(19) United States
(12) Patent Application Publication
(10) Pub. No.: US 2011/0166830 A1
(43) Pub. Date: Jul. 7, 2011

(54) System and apparatus of detecting and controlling the boiling of a liquid

(76) Inventor: Harry V. Lehmann, Novato, CA (US)

(21) Appl. No.: 12/929,211

(22) Filed: Jan. 7, 2011

Related U.S. Application Data
(60) Provisional application No. 61/293,061, filed on Jan. 7, 2010.

(51) Int. Cl. G06F 15/00; H05B 1/02; F24C 3/12; H05B 3/68; H05B 6/68

(52) U.S. Cl. 702/190; 219/506; 219/491; 126/39 BA; 219/446.1; 219/702

(57) ABSTRACT

Acoustic energy (sound) released by a liquid changes upon boiling and increases in some manner as a function of the boiling intensity. Detecting and quantifying the sound emitted from the boiling liquid with a sensor and processor enables a system to not only detect the boiling of a liquid but to assess the relative intensity of the boiling. Incorporated in a feedback loop, any heat source used to boil a liquid may be manipulated to control the boiling of a liquid and avoid the uncertainty associated with control based on temperature only.

### CROSS REFERENCE

This application is a non-provisional application claiming priority of co-pending provisional Application No. 61/293,061 entitled SOUND RECOGNITION CHIP ACTIVATED SWITCH FOR SOUND BASED RE-SETTING OF FLAME STATUS AND FLUID TEMPERATURE CONTROL THROUGH RESULTING ADJUSTMENT OF GAS-FIRED DEVICE filed Jan. 7, 2010. The entirety of which is incorporated herein by reference.

### BACKGROUND

Thermocouple heat application control mechanisms for the boiling of water and the heating of foodstuffs are ubiquitous. A simple and commonly encountered example is the use of a thermocouple switch for turn-down of electric heat in an electric coffee pot, or electric water-heating vessel. Other examples have turn down points short of boiling, and are adjustable such as in slow-cook devices, e.g. a crock pot.

The need for such thermocouple adjustment mechanisms are several; as to foodstuff fluids, desired cooking temperatures are obtained, over-cooking is avoided, and energy is saved. As to the common task of boiling water, the same examples persist; a thermocouple switch within the device typically in the base, is built so that when the ambient fluid temperature to which the thermocouple is exposed reaches a temperature consistent with the existence of a hard boil, the thermocouple switch bends out of contact, and the water is retained in the vessel in a heated state appropriate for hot beverage brewing, but loss of fluid by excessive boil is avoided and electrical energy is saved. However, during boiling of a homogenous liquid such as water, the temperature remains constant during the boiling process.

Through use of multiple thermocouples, a zone of preferred heat is easily obtained within a closed vessel; simply stated, if the “low,” thermocouple detects ambient fluid temperature below a certain level (by which time the “high temp” thermocouple will have for the same temperature reasons reclined to an “in contact” state) then a circuit is thereby closed in the “low” thermocouple switch, and heating begins in the electric coil, until the fluid reaches such a point, such as boiling at which point the “high temp.” thermocouple disengages, the circuit is broken; and heat application is suspended. Energy and fluid may be saved by this.

Attempts to apply a thermocouple switch to cooking with gas encounter many difficulties; and such devices are not commonly encountered, particularly as to stove based applications. Stove burners are by their nature manufactured to be multiple-purpose, each burner being capable of heating contents from any sort of fluid foodstuff or usable for the heating of beverages, or usable, in the most common application the “tea kettle,” for the heating of water, typically to the boiling point, for subsequent use in the composition of hot beverages such as coffee, instant coffee, or tea. The energy saving, and fluid conserving characteristics of a thermocouple-switch-actuated electric kettle for one example, are not available for use on gas fired kitchen stoves.

The result of the unavailability of a stove based thermocouple switch for gas fired tea kettle use is that water is wasted, heat is wasted, flammable gas is wasted, and damage has frequently resulted to kettles left too long upon the flame. The steam powered tea whistle was developed as a sonic warning to the end user of the fact that his or her water was boiling. However these whistles are far less commonly in use than once was the case. The very nature of the steam-containment necessary to the operation of the whistle requires that it be placed at the spout, a hot inconvenience and a burn hazard, and an additional part is required, which then must be tracked and in any event, there is time delay for several factors, before it is possible for the human operator to turn down the gas supply level to the burner involved. Such factors include first that the whistle does not operate at the immediate point of boil, but only when the steam pressure in the vessel has reached such a state as a result of boiling that the speed-of-volume produced and expelled reaches a point that resulting vibratory process in the involved metal reed causes sound, and secondly the person heating the water must come to the scene, often a matter of at least minutes of unnecessary full power flame status.

In the now more common non-whistle equipped scenario upon a gas stove, many is the end user who has educated his or her household with language of color upon encounter with a kettle, damaged by overheating after water evaporation. Those who have not experienced this likely will as some point if without the aid of the current disclosure.

The problems faced by the inventor seeking to apply a temperature cut off motif to the kettle in the gas stove situation are several including the various difficulties of attempting to use a thermocouple switch activation system, necessarily involving wires; of attaching such system to the vessel and that the outside vessel temperature is a best an indirect measure of the boil state of the semi-contained liquid within. An even greater challenge is with respect to the fact that during boiling of a homogenous liquid such as water, the temperature necessarily remains constant during the boiling process. It is equally known that boiling temperature is a function of ambient pressure, and given that the ambient pressure changes as a function of altitude the boiling temperature also varies across these different altitudes. Thus the temperature control and thermocouple device may be least suited to detect, much less regulate, boiling of a liquid.

However, the acoustic energy (sound) released by a liquid does change upon boiling and advantageously fluctuates as a function of the boiling intensity. Therefore it is an object of the disclosed subject matter in order to obviate the deficiencies in the prior art to present a novel system to detect and control the boiling of a liquid by detecting and quantifying the sound emitted from the boiling. A system includes an adjustable heat source, an acoustic sensor to providing a signal responsive to the acoustic energy and a processor that analyses the signal. The system further includes a controller which adjusts the heat source in compliance with a signal from the processor.

It is also an object of the disclosed subject matter to present a novel method of controlling the boiling rate of a liquid. The method includes setting a desired boiling rate, sensing the acoustic energy with a sensor; and producing a signal responsive to the sensed acoustic energy. The method further adjusts the output of a stove in response to the signal to thereby control the boiling rate of the liquid.

It is another object of the disclosed subject matter to present a novel method of determining the boiling rate of a liquid. The method includes monitoring the acoustic energy and producing a signal representative of the acoustic energy. The method then filters the signal for predetermined characteristics and compares the filtered signal to a threshold to thereby determine the presence and intensity of the boiling.

These and many other objects and advantages of the present subject matter will be readily apparent to one skilled in the art to which the invention pertains from a perusal of the claims, the appended drawings, and the following detailed description of preferred embodiments.

### BRIEF DESCRIPTION OF THE DRAWINGS

FIG. 1 illustrates a master-slave controller for controlling the application of heat to control boiling according to an embodiment of the disclosed subject matter.

FIG. 2 is a generalized schematic of a system for controlling the boiling of a liquid according to an embodiment of the disclosed subject matter.

FIG. 3 is a flowchart for a method of controlling the boiling of a liquid according to an embodiment of the disclosed subject matter.

FIG. 4 is a flow chart for a method of determining the boiling rate of a liquid according to an embodiment of the disclosed subject matter.

### DETAILED DESCRIPTION

The disclosed method and device solves for the problem of establishing temperature based control of kettle or pot contents in the gas stove regime, as well as other heat sources. Other heat sources contemplated include natural gas, oil, wood, electrical radiant, electrical resistance, electromagnetic, microwave, induction, and convection stoves or burners.

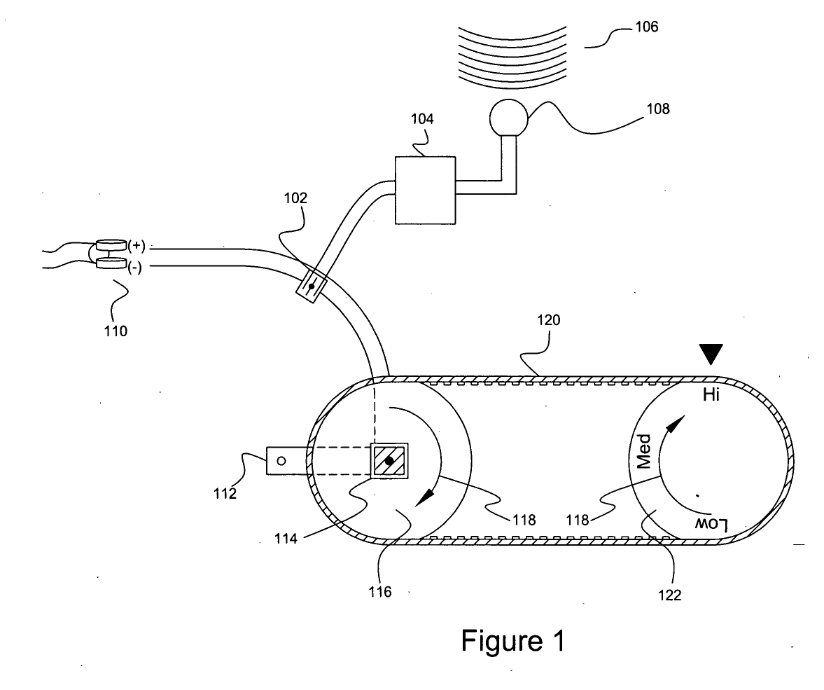

An embodiment of the disclosed subject matter is shown in FIG. 1 as illustrated with respect to a gas stove controlled in a conventional manner. The embodiment of FIG. 1 controls the boiling through the use of a tuned recognition chip 104 or array of chips or processor, tuned to recognize the sound of boiling fluid, or other states of the boiling liquid or flame. These other states may include high flame, low flame, no flame, high boil, medium boil, low boil, this list however is not intended to be exhaustive. A microphone 108 placed in proximity to the liquid to capture the sound 106 created during boiling of a liquid and supplies a signal to the chip 104. The signal may be a analog or digital. Upon analyzing the signal, the chip 104 controls a switch 102. In the embodiment of the FIG. 1, the switch supplies power 110 to an electric motor 114 to drive a master wheel 116 to rotate the gas supply dial 122 that reduces the supply rate of the gas. The rotation of the master wheel 116 is translated to the gas supply dial 122 by way of a toothed track 120. Other mechanisms to rotate the gas supply dial 122 to numerous to list are also envisioned, in addition the mechanism rather than being after market may be integrated during the manufacture of the stove or other heat source. In addition to adjusting the fuel supply rate to control heat output, electrical current, air supply or other parameter influencing heat output of the source may be alternatively controlled.

In FIG. 1 the embodiment activates the switch 102 in response to the sound 106 of boiling fluid, thus closing an electric circuit actuating the electric motor 114 in a servo mechanism (the same necessarily housing-affixed to the stove with bracket 112) which in turn, via the slotted belt 120, causes a turning of the slave dial 122 by the master dial 116 such that the dial 122 is linked to the valve controlling the gas supply in the direction of action 118 shown thus reducing the heat output until the noise associated with the boiling is reduced to predetermined point at which the switch 102 will open. As with many controlled system the activation threshold may be different from the deactivation threshold, to avoid excessive on/off cycling.

The embodiments authenticated herein may be articulated in many differing configurations (including stacked with adjustable pin interface between the stacked elements for reversion to set temperature control) In the alternative to the use of belts as shown herein for simplicity of illustration, embodiments herein may in the alternative of the iteration shown in FIG. 1 be actuated through gear interface between the “master” dial and the “slave,” dial, using gears of any sort including but not limited to planetary, pinion, ring etc.

Subject matter disclosed herein is illustrated with respect to embodiments for the detection of the boiling state of fluids on a gas range or stove via a tuned voice chip or similar tuned sound perception chip, and circuit closing and switch activation to stove mechanism as shown in the attached FIG. 1, tuning of this multiple element dial system through precise tuning of the chip is possible for the recognition of states other than boil, including the state of flame in which there is no pan above, thereby presenting the potential for use of the device to avoid any energy loss or risk of fire associated with the inadvertent leaving of gas stove controls in the “on” condition. Thus the device has many safety implications and in various tuned variants, as to the chip may be of particular use to the elderly. With such detected states an alarm may also be advantageously activated to notify of the “on” condition. The alarm may be visual, aural or mechanical.

The practical provision of power to the master element of the device is an implementation detail, and the most obvious application, given the fixed nature of the relationship between the motor housing and the stove top (as necessary to establish the pivot point for device actuation, in comparison to the dynamic nature of the valve control stem, as currently hand-actuated, is the insertion of wire from household current directly to the fixed aspect; or Master element of the device stack, most conveniently stacked on the bottom of the two devices. However, other means of the provision of power for the device are claimed here, including the integrated us of compact lithium ion batteries, or other batteries, in a removable modular regime, but it is also envisioned with an integrated charging plate, including electrified coil based systems, physically separate from the device, and underlying it, so that power may in said iteration be obtained to the device in said regime without direct wire connection.

Likewise a boil alarm function separate and apart from the controlling function may be advantageous in its own right for alerting user of states. Such an alarm may be composed of a microphone, a sound recognition chip, a switch, and a circuit which is governed by such switch, which upon recognition of the desired state of boil, or state of flame, and upon as a result from such recognition the closing of a switch, completes a circuit so as to electrically power the alarm.

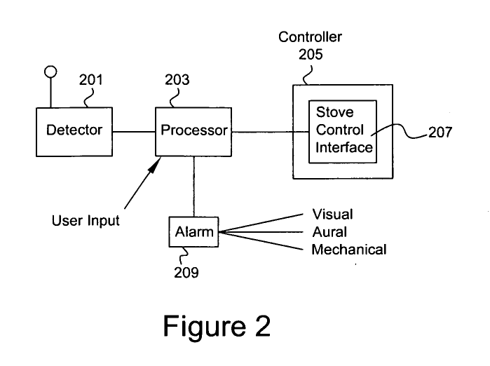

FIG. 2 illustrates schematically components for the controlling of the boiling of a liquid. A detector 201 is a sensor for sensing the acoustic energy proximate to it. The detector 201 may be a microphone or other transducer that creates an electrical signal from the noise vibrations it receives. The electrical signal representative of the sound coming from the liquid may be processed by the processor 203. The processor 203 also may accept user input regarding the desired state of the liquid, volume, nature and desired urgency. The processor 203 evaluates the signal to determine the state of the liquid and controls the operation of the alarm 209 and the controller 205. The controller 205 operates on the Stove control interface 207 such as a dial to the gas supply as discussed earlier and effects adjustments to the output of the heat source. In generally the output of the heat source can be increased, decreased, turned on, or turned off, or cycled through different combinations thereof.

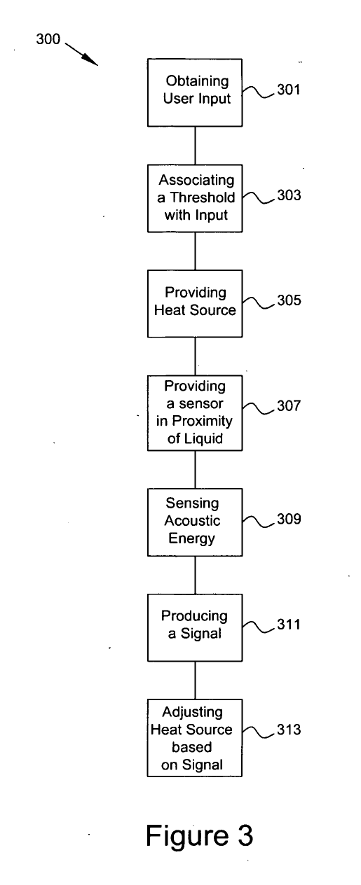

FIG. 3 illustrates a method 300 of controlling the boiling of a liquid. The desired user input is obtained as shown in Block 301. This input may be time of boiling, rate of boiling, volume of liquid or other desired parameter. The user's input is associated with a predetermined threshold as shown in Block 303, for instance if the desired state was a low boil a predetermined frequency associated with a low boil would be used as a reference. A heat source to heat the liquid is provided as shown in Block 305 and the acoustic energy or sound in the proximity of the heated liquid is sensed by an acoustic sensor as shown in Block 309. A signal is then produced reflective of the acoustic environment as shown is Block 311. The acoustic energy may be filtered and processed and compared to at least the threshold selected from the user input and producing the first signal based upon the comparison. The filtering may implement high pass, low pass, slot, notch, integrating, smoothing, attenuating filters to list a few. The heat source is adjusted based on the produced signal as shown in Block 313. Blocks 309, 311 and 313 may be continuously repeated to control the boiling of the liquid.

In producing a signal, one or more characteristics of the acoustic energy may be analyzed. The sound frequencies of boiling may occur within given ranges and may change with respect to the intensity of boiling. Likewise the amplitude of certain frequencies, tones, beat, rhythm and patterns may also change with respect to the intensity of the boiling. Pulse counts and period cycles also may be reflective of the state of the liquid and thus may advantageously be considered in producing the signal. It may also be beneficial to consider the requirements, nature and response of the controller in producing the signal as well as damping functions.

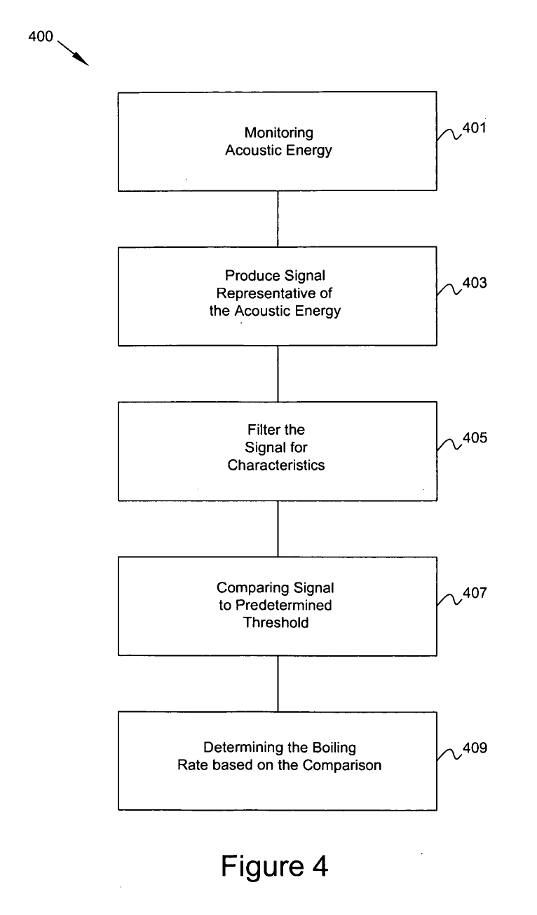

In FIG. 4 a method for determining if a liquid is boiling and preferable its rate is shown. The acoustic energy or sound near the liquid is monitored with a sensor as shown in Block 401. In monitoring the acoustic energy directional or non directional sensors may be used, preferably the sensor is positioned with the least amount interfering energy or attenuation of the relevant sound as possible, however in high noise environments additional filtering or noise cancellation may be employed. A signal is produced as discussed previously which represents the target acoustic energy as shown in Block 403. The signal is filtered for one or more predetermined characteristics to obtain a filtered signal as shown in Block 405. These characteristics include frequency, amplitude, beat, pulse and other as discussed previously and such characteristics are related to the states of the liquid particularly boiling. The filtered signal is then compared to one or more predetermined thresholds as shown in Block 405. The thresholds are derived from characteristics associated with the acoustic energy of the boiling liquid. Based upon the comparison it may be determined that the liquid is boiling and the intensity of the boiling as shown in Block 409. From this determination, the boiling may be controlled or a user alerted to such.

One aspect of the disclosed subject matter is that it is unaffected by changes in altitude since it is the acoustic energy of the actual boiling not the pressure reliant boiling temperature that is detected.

Another aspect of the disclosed subject matter also involves consideration of the temperature of the liquid. Where a temperature sensor is incorporated in proximity to the liquid, the processing of the signal may be predicated upon the temperature range of the liquid. We the temperature lower than 90° C., the processor may use the signal from the acoustic sensor as an indication of ambient noise and configure any filters or weighting, since it would be very unlikely that water in this example would boil at the low temperature. In addition the trend of the temperature correlated to the acoustic sensor signal may serve as a secondary verification source. For example, during boiling of a homogenous liquid the temperature should remain flat regardless of the rate of boiling, therefore if boiling is detected by the acoustic sensor and the temperature does not remain flat, an alarm may be initiated. Thus a comparison of the temperature or temperature trend by be used advantageously.

Yet another aspect of the disclosed subject matter it the substitution of a spectrum sensor for the acoustic sensor. A spectrum sensor could be configure to determining shifts in reflected light waves or radio waves as a result of the boiling, such as surface turbulence or elemental structure shifting.

Still another aspect of the disclosed subject matter its applicability to microwave ovens where the direct visual or aural indications of the boiling of a liquid by the user are more difficult to obtain. The use of an acoustic sensor according to disclosed embodiment within the microwave compartment to control not only the boiling but the heating of the foodstuff would be especially advantageous.

Still yet another aspect of the disclosed subject matter is its industrial use in processing of all nature of liquid chemicals where state changes are required and need to be controlled.

A sound recognition chip and processor are discussed in this description, the sound recognition chip may be any hardware, chip, microprocessor, Application Specific Integrated Circuit (ASIC) or electronic device that meets the functional requirement of distinguishing the acoustic energy produced in boiling a liquid. In addition the processor may be any processor, microprocessor, computer, software, hardware or combination thereof meeting the functional requirements discussed above.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof

I claim:

1. A system to control the boiling rate of a liquid, comprising:
an adjustable heat source;
an acoustic sensor in proximity to the heat source, said acoustic sensor providing a signal, said signal responsive to the acoustic energy proximate the sensor;
a processor;
a controller capable of adjusting a heat output of the heat source in response to a control signal sent by the processor; and,
wherein said processor analyses the signal.

2. The system of claim 1, wherein the controller is a mechanical device, said device comprising: a master wheel; an electric motor, a power source and a toothed belt and a switch; wherein the master wheel is driven by the electric motor, the movement of the master wheel is translated by the toothed belt to a input knob that controls the output of the heat source; and wherein the electric motor rotates in response to power supplied by the power source through he switch, when said switch is in an one condition.

3. The system of claim 2, wherein the processor is a programmed audio chip capable of processing audio signals.

4. The system of claim 3, wherein he acoustic sensor is a microphone.

5. The system of claim 2, wherein the switch is an on off switch.

6. The system of claim 2, wherein the switch reverses polarity to the electric motor.

7. The system of claim 2, wherein the switch is a proportional switch.

8. The system of claim 1, wherein the heat source is a gas.

9. The system of claim 1, wherein the heat source is an electric burner.

10. The system of claim 1, wherein the heat source is electromagnetic waves.

11. The system of claim 1, wherein the processor analyses the signal based on frequency, amplitude, rhythm, profile, pulses or beats.

12. A method of controlling the boiling rate of a liquid;
(a) obtaining user input reflective of a desired boiling rate of the liquid;
(b) associating a threshold with the user input;
(c) providing a heat source in proximity to the liquid;
(d) providing a acoustic sensor in proximity of the liquid;
(e) sensing the acoustic energy with the acoustic sensor;
(f) producing a first signal responsive to the acoustic energy; and,
(g) adjusting the output of the heat source in response to the first signal to thereby control the boiling rate of the liquid.

13. The method of claim 12, wherein the step of producing a first signal responsive to the acoustic energy further comprises comparing the acoustic energy to at least one predetermined threshold and producing the first signal based upon the comparison

14. The method of claim 12, further comprising repeating steps (e)-(g)

15. The method of claim 13, wherein step (g) further comprises driving a master wheel with an electric motor and translating the master wheels rotation to a dial of the heat source to thereby adjust the output of the heat source.

16. The method of claim 12, wherein step (f) further comprises analyzing one or more characteristics of the acoustic energy.

17. The method of claim 16, wherein the one or more characteristics are frequency, beats amplitude, rhythm, signal profile or signal pulses.

18. The method of claim 12, further comprising alerting the user the status of the liquid based on the first signal, wherein said alert may be visual, aural or mechanical.

19. A method of determining the boiling rate of a liquid:
monitoring the acoustic energy proximate to the liquid;
producing at least one signal representative of the acoustic energy;
filtering the at least one signal for one or more predetermined characteristics to obtain a filter signal;
comparing the filtered signal against one or more predetermined thresholds; and,
determining the boiling rate as a function of the comparison.

20. The method of claim 19, wherein the one or more predetermined characteristics are selected from the group consisting of frequency, amplitude, beats, rhythm, pulse count, pulse duration.

21. The method of claim 19, further comprising sampling the temperature of the liquid over a time period; wherein the determining is at least a function of the sampling.
